(19) United States
(12) Patent Application Publication
(10) Pub. No.: US 2025/0095887 A1
(43) Pub. Date: Mar. 20, 2025

(54) OVER-CURRENT PROTECTION DEVICE

(71) Applicant: Polytronics Technology Corp., HSINCHU (TW)

(72) Inventors: CHENG-YU TUNG, Tainan City (TW); Chia-Yuan Lee, Hsinchu City (TW); HSIU-CHE YEN, Taoyuan City (TW); CHINGTING CHIU, Taoyuan City (TW); CHEN-NAN LIU, Changhua County (TW); YUNG-HSIEN CHANG, Douliu City (TW); Yao-Te Chang, Yunlin County (TW); FU-HUA CHU, TAIPEI CITY (TW)

(21) Appl. No.: 18/636,873

(22) Filed: Apr. 16, 2024

(30) Foreign Application Priority Data
Sep. 20, 2023 (TW) 112135900

(51) Int. Cl. H01C 7/02; H01C 1/14

(52) U.S. Cl. CPC H01C 7/021; H01C 1/1406; H01C 7/028

(57) ABSTRACT

An over-current protection device includes an electrode layer and a heat-sensitive layer. The heat-sensitive layer exhibits a positive temperature coefficient (PTC) characteristic, and is laminated between a top metal layer and a bottom metal layer of the electrode layer. The heat-sensitive layer includes a polymer matrix and a conductive filler. The polymer matrix includes a fluoropolymer. The fluoropolymer has a plurality of spherulites, and the fractal dimension of each spherulite is lower than 12.

### BACKGROUND OF THE INVENTION

### (1) Field of the Invention

The present application relates to an over-current protection device, and more specifically, to an over-current protection device with high durability.

### (2) Description of the Related Art

Because the electrical resistance of conductive composite materials having a positive temperature coefficient (PTC) characteristic is very sensitive to temperature variation, they can be used as the materials for current sensing devices and have been widely applied to over-current protection devices or circuit devices. More specifically, the electrical resistance of the PTC conductive composite material remains extremely low at normal temperatures, so that the circuit or battery cell can operate normally. However, when an over-current or an over-temperature situation occurs in the circuit or cell, the electrical resistance will instantaneously increase to a high electrical resistance state (e.g., at least above 104Ω), which is the so-called “trip”. Therefore, the over-current will be eliminated so as to protect the cell or the circuit device.

The basic structure of an over-current protection device consists of a PTC material layer with two electrodes bonded to two opposite sides of the PTC material layer. The PTC material layer includes a matrix and a conductive filler. The matrix consists of at least one polymer, and the conductive filler is uniformly dispersed in the matrix and is used as an electrically conductive path. Given the need for overheating protection at high temperatures, a fluoropolymer (e.g., polyvinylidene difluoride) is typically selected as the major constituent in the matrix. Conventionally, additional additives need to be incorporated in order to effectively improve the service life (i.e., durability) of the aforementioned over-current protection device under high voltage. However, the introduction of extra additives often complicates the formulation design. For instance, it is crucial to consider compatibility among the additional additives, polymers, and the conductive filler. Once compatibility is assessed and the suitable additives are chosen, the proportion between the polymers and the conductive filler must be adjusted appropriately to maintain excellent electrical characteristics. In the time of fast-changing technologies, the formulation design is frequently improved on the prior basis. Each introduction of a new compound adds to the complexity, which makes further improvements more challenging in the future.

Moreover, it is understood that miniaturization of devices becomes a trend in order to efficiently utilize available space and align with energy-saving and carbon reduction policies. However, defects in various electrical characteristics are prone to exacerbation as the size of the over-current protection device decreases. If one intends to improve the physical/chemical properties of the polymer itself, achieving significant breakthroughs is often challenging due to the amplification of defects caused by the decreasing size.

Accordingly, there is still room for enhancement in terms of durability of the conventional over-current protection device.

### SUMMARY OF THE INVENTION

The present invention provides an over-current protection device with high durability. The over-current protection device includes an electrode layer and a heat-sensitive layer. The electrode layer is a layer for electrical connection, while the heat-sensitive layer, including a polymer matrix and a conductive filler, is a layer used to exhibit a positive temperature coefficient (PTC) characteristic. The present invention focuses on the surface complexity of a microstructure (i.e., fractal dimension of a spherulite's surface) and its size (i.e., radius of the spherulite) in the polymer matrix. This enables the over-current protection device to withstand a high voltage for a high cycle number without burnout in a cycle life test. Also, the thickness of the over-current protection device can be significantly reduced.

In accordance with an aspect of the present invention, an over-current protection device includes an electrode layer and a heat-sensitive layer. The electrode layer has a top metal layer and a bottom metal layer. The heat-sensitive layer contacts the top metal layer and the bottom metal layer, and is laminated therebetween. The heat-sensitive layer exhibits a positive temperature coefficient (PTC) characteristic and includes a polymer matrix and a conductive filler. The polymer matrix includes a fluoropolymer, wherein the fluoropolymer has a plurality of spherulites, and a fractal dimension of each spherulite is equal to or less than 12. The conductive filler is dispersed in the polymer matrix, thereby forming an electrically conductive path in the heat-sensitive layer.

In an embodiment, the fractal dimension of each spherulite ranges from 7 to 12.

In an embodiment, each spherulite has a radius at least of 35 Å.

In an embodiment, the radius of each spherulite ranges from 35 Å to 43 Å.

In an embodiment, the total volume of the heat-sensitive layer is calculated as 100%, and the fluoropolymer accounts for 55% to 68%.

In an embodiment, the fluoropolymer is selected from the group consisting of polyvinylidene difluoride, polytetrafluoroethylene, ethylene-tetrafluoroethylene copolymer, tetrafluoroethylene-hexafluoro-propylene copolymer, perfluoroalkoxy modified tetrafluoroethylenes, poly (chlorotrifluorotetrafluoroethylene), vinylidene fluoride-tetrafluoroethylene copolymer, tetrafluoroethylene-perfluorodioxole copolymer, vinylidene fluoride-hexafluoropropylene copolymer, and vinylidene fluoride-hexafluoropropylene-tetrafluoroethylene terpolymer, and a mixture or copolymer of combinations thereof.

In an embodiment, the fluoropolymer consists of polyvinylidene difluoride and polytetrafluoroethylene.

In an embodiment, the total volume of the heat-sensitive layer is calculated as 100%, and polyvinylidene difluoride accounts for 56% to 62% and polytetrafluoroethylene accounts for 3% to 5%.

In an embodiment, the conductive filler consists of carbon black.

In an embodiment, the heat-sensitive layer has a thickness ranging from 0.1 mm to 0.2 mm.

In an embodiment, the over-current protection device has a top-view area ranging from 4 mm² to 16 mm².

In an embodiment, the over-current protection device has a first resistance-jump ratio ranging from 1 to 3. The over-current protection device has an initial electrical resistance; the over-current protection device has a first electrical resistance when cooled back to room temperature after a cycle life test with an applied power of 24V/50 A for 6000 cycles; and the first resistance-jump ratio is obtained by dividing the first electrical resistance by the initial electrical resistance.

In an embodiment, the over-current protection device has a second resistance-jump ratio ranging from 2 to 5. The over-current protection device has an initial electrical resistance; the over-current protection device has a second electrical resistance when cooled back to room temperature after a cycle life test with an applied power of 30V/40 A for 6000 cycles; and the second resistance-jump ratio is obtained by dividing the second electrical resistance by the initial electrical resistance.

In an embodiment, an endurable voltage of the over-current protection device is 36V, by which the over-current protection device is able to withstand an applied power of 36V/33 A for 6000 cycles without burnout.

In an embodiment, the over-current protection device has a third resistance-jump ratio ranging from 3 to 9. The over-current protection device has an initial electrical resistance; the over-current protection device has a third electrical resistance when cooled back to room temperature after a cycle life test with an applied power of 36V/33 A for 6000 cycles; and the third resistance-jump ratio is obtained by dividing the third electrical resistance by the initial electrical resistance.

### BRIEF DESCRIPTION OF THE DRAWINGS

The present application will be described according to the appended drawings in which:

FIG. 1 shows a cross-sectional view of an over-current protection device in accordance with an embodiment of the present invention;

FIG. 2 shows the top view of the over-current protection device shown in FIG. 1; and

FIG. 3 to FIG. 5 show results from small angle X-ray scattering (SAXS) analysis.

### DETAILED DESCRIPTION OF THE INVENTION

The making and using of the presently preferred illustrative embodiments are discussed in detail below. It should be appreciated, however, that the present application provides many applicable inventive concepts that can be embodied in a wide variety of specific contexts. The specific illustrative embodiments discussed are merely illustrative of specific ways to make and use the invention, and do not limit the scope of the invention.

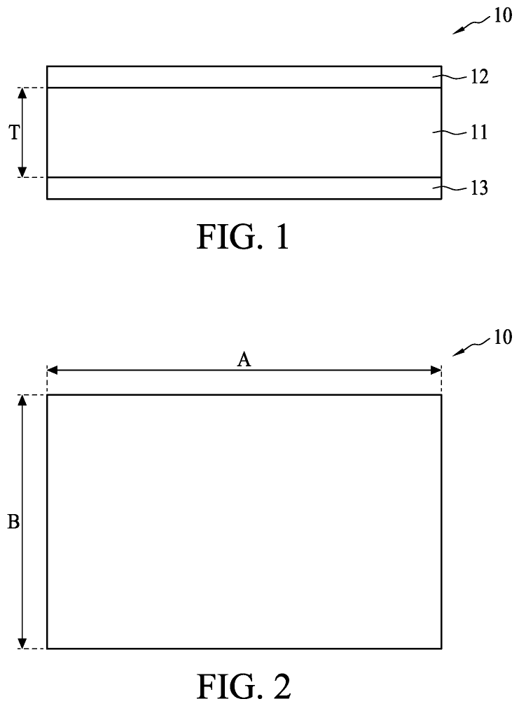

Please refer to FIG. 1. FIG. 1 shows one basic aspect of an over-current protection device 10 of the present invention in cross-sectional view. The over-current protection device 10 includes a heat-sensitive layer 11 and an electrode layer. The heat-sensitive layer 11 has a top surface and a bottom surface, and the electrode layer has a top metal layer 12 and a bottom metal layer 13 attached to the top surface and the bottom surface, respectively. Therefore, the heat-sensitive layer 11 physically contacts the top metal layer 12 and the bottom metal layer 13, and is laminated therebetween. In an embodiment, the top metal layer 12 and the bottom metal layer 13 may be composed of the nickel-plated copper foils or other conductive metals. In addition, the heat-sensitive layer 11 includes a polymer matrix and a conductive filler. The polymer matrix is an electrical insulator sensitive to heat, and the conductive filler is an electrical conductor, by which the heat-sensitive layer 11 exhibits PTC characteristic. The over-current protection device 10 does not operate under normal condition, and therefore the conductive filler is uniformly dispersed in the polymer matrix, and particles of the conductive filler connect to each other in series, thereby forming an electrically conductive path; however, the polymer matrix rapidly expands when the over-current protection device 10 is subject to high temperature, and the particles of the conductive filler are pulled away from each other, thereby cutting off the electrically conductive path.

In the present invention, the polymer matrix consists of a fluoropolymer, and such fluoropolymer may consist of one or more fluoro-based polymers. More specifically, the fluoropolymer is selected from the group consisting of polyvinylidene difluoride, polytetrafluoroethylene, ethylene-tetrafluoroethylene copolymer, tetrafluoroethylene-hexafluoro-propylene copolymer, perfluoroalkoxy modified tetrafluoroethylenes, poly (chlorotri-fluorotetrafluoroethylene), vinylidene fluoride-tetrafluoroethylene copolymer, tetrafluoroethylene-perfluorodioxole copolymer, vinylidene fluoride-hexafluoropropylene copolymer, and vinylidene fluoride-hexafluoropropylene-tetrafluoroethylene terpolymer, and a mixture or copolymer of combinations thereof. In an embodiment, the fluoropolymer consists of polyvinylidene difluoride and polytetrafluoroethylene. The present invention aims to modify certain features of a microstructure of the fluoropolymer (i.e., fractal dimension of a spherulite's surface and radius of the spherulite), thereby significantly improving the electrical characteristics of the over-current protection device 10.

It is noted that the aforementioned fluoropolymer is a semi-crystalline polymer. In terms of its crystalline structure, it can be roughly divided into a region with polymer chains in an ordered arrangement (i.e., crystalline region) and a region with polymer chains in a disordered arrangement (i.e., amorphous region). In the crystalline region, the polymer chains are orderly folded into the minimum unit of the crystalline structure. These folded polymer chains are further stacked into a lamella, and then a plurality of lamellae are packaged into a spherulite. Accordingly, a plurality of spherulites may constitute the aforementioned crystalline region in the polymer. With the advent of fractal mathematics, it is feasible to express the complexity of each spherulite's surface in fractal dimension. The greater the fractal dimension, the more complex the spherulite's surface becomes. In other words, the spherulite's surface becomes more uneven as the fractal dimension increases. Conversely, the smaller the fractal dimension, the less complex the spherulite's surface becomes. In other words, the spherulite's surface becomes more even as the fractal dimension decreases. It is understood that the complexity of the spherulite's surface is relevant to the structural stability of the spherulite. The factors contributing to the structural stability may include degree of cross-linking between molecular chains and/or other unexpected physical or chemical properties. For instance, in the polymer, molecular chains with a high degree of cross-linking may be more stable, forming each spherulite with an even or smooth surface. Therefore, the present invention controls the fractal dimension of the spherulite's surface within a range equal to or less than 12. If the fractal dimension is equal to or less than 12, the spherulites of the fluoropolymer exhibit the smoother surfaces. The stability of these spherulites is sufficient to ensure excellent performance in a durability test, as shown in Table 3. In an embodiment, the fractal dimension ranges from 7 to 12. In an embodiment, the fractal dimension is 7, 8, 9, 10, 11, or 12. In another embodiment, the fractal dimension is 7.9, 9.8, 10.9, or 11.6. Moreover, the present invention also controls the spherulite's radius to be at least 35 Å. Compared with small spherulites, when large spherulites occupy a specific space, the exposed areas (i.e., interfaces between spherulites or amorphous regions) are more concentrated. Therefore, particles of the conductive filler are more easily to connect with each other, forming an electrically conductive path. If the spherulite's radius is greater than a specific value (e.g., the aforementioned 35 Å), large spherulites are more likely to reform during the process of recrystallization after a trip event. This facilitates rapid reconnection of the particles of the conductive filler, allowing the over-current protection device 10 to return to a state of low electrical resistance. However, the spherulite's radius should not be excessively large; otherwise, it may lead to an overly concentrated distribution of the conductive filler (i.e., excessive distribution at the interfaces between spherulites or amorphous regions). As a result, in an embodiment, the spherulite's radius ranges from 35 Å to 43 Å. In an embodiment, the spherulite's radius is 35 Å, 36 Å, 37 Å, 38 Å, 39 Å, 40 Å, 41 Å, 42 Å, or 43 Å. In another embodiment, the spherulite's radius is 38 Å, 36 Å, 40 Å, or 41 Å. The microstructures (i.e., spherulites) of the fluoropolymer may be modified through various methods, such as thermal treatment, irradiation, and/or different polymerization methods. After that, the spherulite's fractal dimension and radius can be confirmed and analyzed through a small angle X-ray scattering (SAXS) instrument.

In addition, in order to ensure good trip characteristics of the over-current protection device 10, the volume of the fluoropolymer should exceed half the volume of the heat-sensitive layer 11. For example, the total volume of the heat-sensitive layer 11 is calculated as 100%, and the fluoropolymer accounts for 55% to 68%. In an embodiment, the volume percentage of the fluoropolymer is 55%, 56%, 57%, 58%, 59%, 60%, 61%, 62%, 63%, 64%, 65%, 67%, or 68%. As described above, the fluoropolymer may consist of polyvinylidene difluoride and polytetrafluoroethylene. The total volume of the heat-sensitive layer 11 is calculated as 100%, and polyvinylidene difluoride may vary within a range from 56% to 62% and polytetrafluoroethylene may vary within a range from 3% to 5%. For example, in an embodiment, the total volume of the heat-sensitive layer 11 is calculated as 100%, and polyvinylidene difluoride accounts for 58% and polytetrafluoroethylene accounts for 4%. In another embodiment, the proportion of polytetrafluoroethylene is higher in order to enhance thermal stability or meet other requirements. For example, the total volume of the heat-sensitive layer 11 is calculated as 100%, and polyvinylidene difluoride accounts for 56% and polytetrafluoroethylene accounts for 5%.

As for the conductive filler, it consists of carbon black in the present invention. That is, the conductive filler of the present invention is only made of carbon black, and does not include any electrically conductive ceramic material for the electrically conductive path. The electrically conductive ceramic material is selected from the group consisting of tungsten carbide, titanium carbide, vanadium carbide, zirconium carbide, niobium carbide, tantalum carbide, molybdenum carbide, hafnium carbide, titanium boride, vanadium boride, zirconium boride, niobium boride, molybdenum boride, hafnium boride, zirconium nitride, and any combination thereof. If the conductive filler includes the electrically conductive ceramic material, the over-current protection device 10 is easily burnt out during the subsequent durability test.

Please refer to FIG. 1 and FIG. 2. It is noted that the over-current protection device 10 of the present invention may be reduced to a smaller size (i.e., smaller length, width, and thickness) while maintaining good durability if it adopts the improvements as previously mentioned. Conventionally, the thickness of the heat-sensitive layer needs to be at least 0.28 mm to ensure the device's voltage endurance, yield rate in the manufacturing process, or other device's performance. In contrast, the present invention allows for a significant reduction in thickness of the heat-sensitive layer 11 while maintaining excellent durability. As shown in FIG. 1, the thickness T of the heat-sensitive layer 11 ranges from 0.1 mm to 0.2 mm, such as 0.1 mm, 0.11 mm, 0.12 mm, 0.13 mm, 0.14 mm, 0.15 mm, 0.16 mm, 0.17 mm, 0.18 mm, 0.19 mm, or 0.2 mm. This flexibility in thickness enables the combination of the extremely thin heat-sensitive layer 11 with electrode layers of varying thicknesses, facilitating the production of over-current protection devices 10 with different thickness specifications to meet the industrial demand. In other words, the freedom of choice in terms of thickness for the electrode layer is also more flexible. The over-current protection device 10 has a length A and a width B, and the top-view area “A×B” of the over-current protection device 10 is substantially equivalent to the top-view area of the heat-sensitive layer 11. The heat-sensitive layer 11 may have a top-view area ranging from 4 mm² to 16 mm² based on the size of different products. For example, the top-view area “A×B” may be 2×2 mm², 2.3×2.3 mm², 2.5×3 mm², 2.8×3.5 mm², 3×4 mm², or 4×4 mm². It is understood that the present invention can apply to any size of the over-current protection device 10 described above to achieve the same technical effect. The over-current protection device 10 can be processed into different device types commonly used in the industry, such as surface-mount device (SMD), axial-leaded device (ALD), radial-leaded device (RLD), or other device types, depending on the requirements.

Based on the above composition and dimensions, the over-current protection device 10 of the present invention may include improved resistance stability and durability. The following description is provided with a durability test. The durability test includes three types of cycle life tests (referred to as first cycle life test, second cycle life test, and third cycle life test hereinafter). One cycle of each cycle life test includes applying a specific power for 10 seconds and then turning it off for 60 seconds (i.e., on: 10 seconds; off: 60 seconds).

In the first cycle life test, the over-current protection device 10 demonstrates a first resistance-jump ratio ranging from 1 to 3. More specifically, the over-current protection device 10 has an initial electrical resistance; after a cycle life test with an applied power of 24V/50 A for 6000 cycles, the over-current protection device 10 has a first electrical resistance when it is cooled back to room temperature. The first resistance-jump ratio is defined as a value obtained by dividing the first electrical resistance by the initial electrical resistance. The first resistance-jump ratio of the conventional over-current protection device is typically at least 5, which is much higher than the first resistance-jump ratio of the over-current protection device 10 of the present invention. This indicates that the over-current protection device 10 of the present invention exhibits superior resistance stability.

In the second cycle life test, the over-current protection device 10 demonstrates a second resistance-jump ratio ranging from 2 to 5. More specifically, the over-current protection device 10 has an initial electrical resistance; after a cycle life test with an applied power of 30V/40 A for 6000 cycles, the over-current protection device 10 has a second electrical resistance when it is cooled back to room temperature. The second resistance-jump ratio is defined as a value obtained by dividing the second electrical resistance by the initial electrical resistance. The second resistance-jump ratio of the conventional over-current protection device is typically at least 10, which is much higher than the second resistance-jump ratio of the over-current protection device 10 of the present invention. This indicates that the over-current protection device 10 of the present invention exhibits superior resistance stability.

In the third cycle life test, the over-current protection device 10 demonstrates a third resistance-jump ratio ranging from 3 to 9. More specifically, the over-current protection device 10 has an initial electrical resistance; after a cycle life test with an applied power of 36V/33 A for 6000 cycles, the over-current protection device 10 has a third electrical resistance when it is cooled back to room temperature. The third resistance-jump ratio is defined as a value obtained by dividing the third electrical resistance by the initial electrical resistance. In the third cycle life test, it is noted that the conventional over-current protection device is burnt out due to the aforementioned high voltage, rendering the measurement of its third electrical resistance impossible. In other words, the over-current protection device 10 of the present invention exhibits excellent voltage endurance compared to the conventional one.

In order to provide a more specific description of the technical content of the present invention, Tables 1 to 3 shown below are further discussed using actual verification data.

TABLE 1
Volume percentage (vol %) of the heat-sensitive layer.

| | PVDF | PTFE | Mg(OH)₂ | CB |
|---|---|---|---|---|
| heat-sensitive layer | 58.5 | 4.5 | 3.1 | 33.9 |

TABLE 2
Features of the microstructure of the polymer matrix

| Group | Dₘ | R_{g} (Å) |
|---|---|---|
| C1 | 12.907 | 21.0 |
| C2 | 12.071 | 34.0 |
| E1 | 11.556 | 38.0 |
| E2 | 10.935 | 36.0 |
| E3 | 9.846 | 41.0 |
| E4 | 7.873 | 40.0 |

Table 1 shows the volume percentage composition of the heat-sensitive layer 11. In the experiment, the heat-sensitive layer 11 is made of polyvinylidene difluoride (PVDF), polytetrafluoroethylene (PTFE), magnesium hydroxide (Mg(OH)₂), and carbon black (CB). PVDF and PTFE together constitute the polymer matrix of the heat-sensitive layer 11, while carbon black is dispersed within the polymer matrix and used as the electrically conductive path. Magnesium hydroxide acts as the flame retardant, and can neutralize the hydrofluoric acid produced by PVDF during its degradation. As previously mentioned, the conductive filler consists of carbon black, and does not include any electrically conductive ceramic material for the electrically conductive path.

The manufacturing process of the over-current protection devices of the embodiments E1 to E4 and the comparative examples C1 to C2 is described below. According to the composition shown in Table 1, materials are prepared and put into HAAKE twin screw blender for blending. The blending temperature is 215° C., the time for pre-mixing is 3 minutes, and the blending time is 15 minutes. The conductive polymer after being blended is pressed into a sheet by a hot press machine at a temperature of 210° C. and a pressure of 150 kg/cm². The sheet is then cut into pieces of about 20 cm×20 cm, and two nickel-plated copper foils are laminated to two sides of the sheet with the hot press machine at a temperature of 210° C. and a pressure of 150 kg/cm², by which a three-layered structure is formed. Then, the sheet with the nickel-plated copper foils is punched into PTC chips, each of which is the over-current protection device. Each PTC chip has a length A, a width B, and a thickness T, which are 3 mm, 4 mm, and 0.13 mm, respectively. Then, the PTC chips of the embodiments and comparative examples are subjected to thermal treatments. In the comparative example C1, the PTC chip is heated at 80° C. for 4 hours; in the comparative example C2, the PTC chip is heated at 100° C. for 4 hours; in the embodiment E1, the PTC chip is heated at 120° C. for 3 hours; in the embodiment E2, the PTC chip is heated at 140° C. for 2 hours; in the embodiment E3, the PTC chip is heated at 160° C. for 2 hours; and in the embodiment E4, the PTC chip is heated at 170° C. for 2 hours. According to the different thermal treatments, the surface complexity and the size of the spherulite can be adjusted, and then are analyzed by the SAXS instrument to give the results listed in Table 2 above.

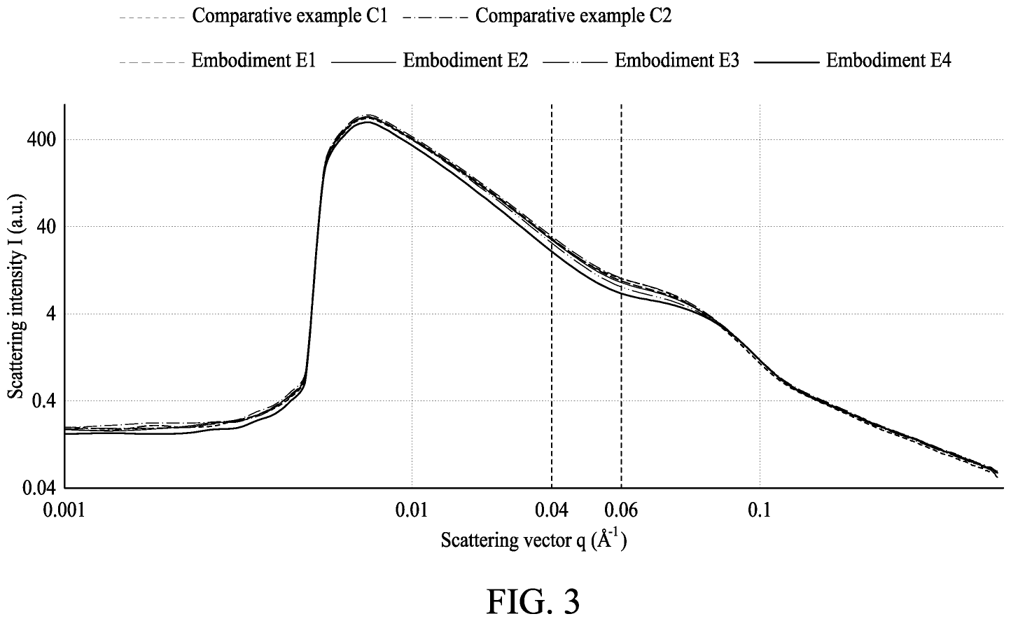

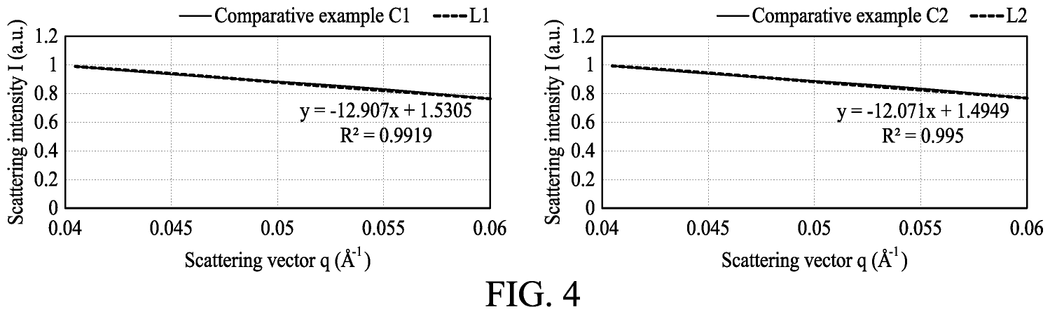

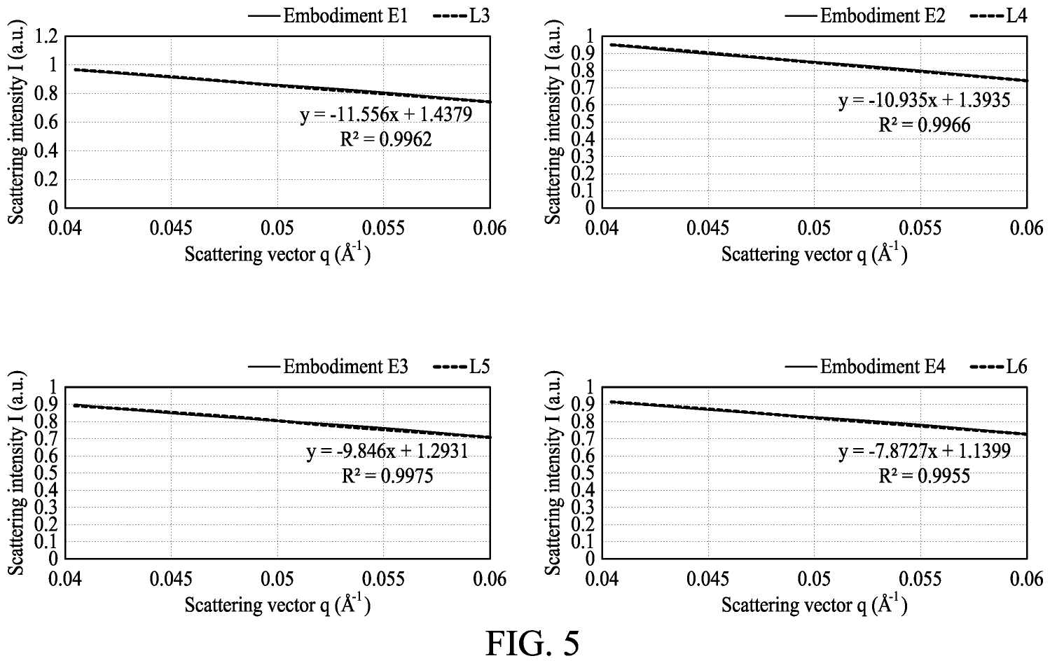

Please refer to Table 2 and FIG. 3 to FIG. 5. In FIG. 3, the X-axis indicates the scattering vector q, and the Y-axis indicates the scattering intensity I. SAXS can be used to resolve the scattering features with scattering vector q lower than 0.1 Å⁻¹. As the scattering vector q decreases, the corresponding structural size becomes smaller. As the scattering vector q increases, the corresponding structural size becomes larger. In the range of scattering vector q from 0.04 Å⁻¹ to 0.06 Å⁻¹, each resulting curve within this range may correspond to the scattering features of one spherulite. After analysis using SASView software, the fractal dimension (Dₘ) and radius of gyration (R_{g}) of each spherulite can be obtained. Regarding the fractal dimension (Dₘ), a fitted straight line corresponding to each resulting curve can be plotted (as shown in FIG. 4 and FIG. 5) through fitting. In accordance with Porod law, the slope of the fitted straight line in absolute value represents the fractal dimension (Dₘ), which can be used to assess the complexity of the spherulite's surface. For ease of understanding, each resulting curve in FIG. 4 and FIG. 5 is isolated from FIG. 3 and displayed individually within the interval of 0.04 Å⁻¹ to 0.06 Å⁻¹. In FIG. 4 and FIG. 5, each resulting curve is illustrated in solid line, and its corresponding fitted straight line is illustrated in dashed line. Please refer to FIG. 4. A straight line L1 is fitted from the resulting curve of the comparative example C1, and the equation of the straight line L1 is y=−12.907x+1.5305. The slope of the straight line L1 in absolute value is 12.907, which is the fractal dimension (Dₘ) of the comparative example C1. A straight line L2 is fitted from the resulting curve of the comparative example C2, and the equation of the straight line L2 is y=−12.071x+1.4949. The slope of the straight line L2 in absolute value is 12.071, which is the fractal dimension (Dₘ) of the comparative example C2. Please refer to FIG. 5. A straight line L3 is fitted from the resulting curve of the embodiment E1, and the equation of the straight line L3 is y=−11.556x+1.4379. The slope of the straight line L3 in absolute value is 11.556, which is the fractal dimension (Dₘ) of the embodiment E1. A straight line L4 is fitted from the resulting curve of the embodiment E2, and the equation of the straight line L4 is y=−10.935x+1.3935. The slope of the straight line L4 in absolute value is 10.935, which is the fractal dimension (Dₘ) of the embodiment E2. A straight line L5 is fitted from the resulting curve of the embodiment E3, and the equation of the straight line L5 is y=−9.846x+1.2931. The slope of the straight line L5 in absolute value is 9.846, which is the fractal dimension (Dₘ) of the embodiment E3. A straight line L6 is fitted from the resulting curve of the embodiment E4, and the equation of the straight line L6 is y=−7.8727x+1.1399. The slope of the straight line L6 in absolute value is 7.8727, which is the fractal dimension (Dₘ) of the embodiment E4. In FIG. 4 and FIG. 5, R² represents the proportion of variance between the fitted straight line and the resulting curve. As the value of R² approaches 1, the variability between the fitted straight line and the resulting curve becomes small, indicating a better fit between them. As for the aforementioned radius of gyration (R_{g}), it can be calculated by using SASView software in accordance with Guinier law. R_{g} may also be referred to as a gyration radius of a particle. This parameter helps determine the rotation around an axis of a single spherulite in space, thereby defining it as the radius of that spherulite.

Based on the adjustments in Table 2, the durability of each group is tested through cycle life tests under various conditions.

TABLE 3
Durability test

| | Rᵢ | ρᵢ | R_{6000C1} | | R_{6000C2} | | R_{6000C3} | |
|---|---|---|---|---|---|---|---|---|
| Group | (Ω) | (Ω · cm) | (Ω) | R_{6000C1}/Rᵢ | (Ω) | R_{6000C2}/Rᵢ | (Ω) | R_{6000C3}/Rᵢ |
| C1 | 0.0879 | 0.413 | 0.5037 | 5.73 | 0.9093 | 10.35 | — | — |
| C2 | 0.0906 | 0.426 | 0.3436 | 3.79 | 0.8642 | 9.54 | — | — |
| E1 | 0.1016 | 0.478 | 0.2839 | 2.79 | 0.4578 | 4.50 | 0.8600 | 8.46 |
| E2 | 0.1057 | 0.497 | 0.2824 | 2.67 | 0.3503 | 3.31 | 0.5127 | 4.85 |
| E3 | 0.1462 | 0.687 | 0.1735 | 1.19 | 0.3127 | 2.14 | 0.4452 | 3.05 |
| E4 | 0.149 | 0.701 | 0.1882 | 1.26 | 0.3093 | 2.07 | 0.4516 | 3.03 |

“Rᵢ” refers to the initial electrical resistance of the over-current protection device at room temperature. In addition, the electrical resistance formula is ρ=R×A/L, where “R” is electrical resistance, “L” is length (thickness), and “A” is cross sectional area. Accordingly, the electrical resistivity ρᵢ can be calculated based on Rᵢ.

“R_{6000C1}” refers to the first electrical resistance of the over-current protection device when it is cooled back to room temperature after the first cycle life test for 6000 cycles. One cycle of the first cycle life test involves applying 24V/50 A for 10 seconds and then turning it off for 60 seconds, and 6000 cycles above are performed.

“R_{6000C2}” refers to the second electrical resistance of the over-current protection device when it is cooled back to room temperature after the second cycle life test for 6000 cycles. One cycle of the second cycle life test involves applying 30V/40 A for 10 seconds and then turning it off for 60 seconds, and 6000 cycles above are performed.

“R_{6000C3}” refers to the third electrical resistance of the over-current protection device when it is cooled back to room temperature after the third cycle life test for 6000 cycles. One cycle of the third cycle life test involves applying 36V/33 A for 10 seconds and then turning it off for 60 seconds, and 6000 cycles above are performed.

R_{6000C1}/Rᵢ, R_{6000C2}/Rᵢ, and R_{6000C3}/Rᵢ are the aforementioned first resistance-jump ratio, second resistance-jump ratio, and third resistance-jump ratio, respectively. The resistance-jump ratio can be used to assess the resistance recovery capability of the over-current protection device after multiple trip events. The lower the value, the better the ability of the over-current protection device to restore to a low electrical resistance state.

Regarding the initial electrical resistance (Rᵢ) and electrical resistivity (ρᵢ), there is no significant difference between the embodiments E1 to E4 and the comparative examples C1 to C2 in either one of them. More specifically, in the embodiments E1 to E4, the initial electrical resistance (Rᵢ) ranges from 0.1016Ω to 0.149Ω, and the electrical resistivity (ρᵢ) ranges from 0.478 (2·cm to 0.701 (2·cm; and in the comparative examples C1 to C2, the initial electrical resistance (Rᵢ) ranges from 0.0879 (to 0.0906 (2, and the electrical resistivity (ρᵢ) ranges from 0.413 Ω·cm to 0.426 Ω·cm. However, after multiple trip events (e.g., the aforementioned cycle life tests), the embodiments E1 to E4 can significantly demonstrate their advantages in terms of resistance stability and durability. After the first cycle life test, the embodiments E1 to E4 show that the first electrical resistance (R_{6000C1}) ranges from 0.1735Ω to 0.2839Ω and the first resistance-jump ratio (R_{6000C1}/Rᵢ) ranges from 1.19 to 2.79. Both ranges are significantly lower compared to those of the comparative examples C1 to C2. This indicates that the over-current protection devices of the embodiments E1 to E4 can recover to a lower electrical resistance state after 6000 cycles at 24V/50A, exhibiting excellent resistance stability. For the second cycle life test, the applied voltage is increased. After the second cycle life test, the embodiments E1 to E4 show that second electrical resistance (R_{6000C2}) ranges from 0.3093Ω to 0.4578Ω and the second resistance-jump ratio (R_{6000C2}/Rᵢ) ranges from 2.07 to 4.5. Likewise, both ranges are significantly lower compared to those of the comparative examples C1 to C2, indicating that the over-current protection devices of the embodiments E1 to E4 can recover to a lower electrical resistance state after 6000 cycles at 30V/40A, exhibiting excellent resistance stability. In order to further compare the service life (i.e., durability) between the embodiments and comparative examples, the third cycle life test increases the applied voltage to 36V. In Table 3, after the third cycle life test, the over-current protection devices of the comparative examples C1 and C2 are burnt out, and therefore the third electrical resistance (R_{6000C3}) and the third resistance-jump ratio (R_{6000C3}/Rᵢ) cannot be measured. However, the over-current protection devices of the embodiments E1 to E4 are not burnt out after the third cycle life test, and they can be reused several times without replacement, maintaining their protection function. In the embodiments E1 to E4, the third electrical resistance (R_{6000C3}) ranges from 0.4452 $2 to 0.86 2, and the third resistance-jump ratio (R_{6000C3}/Rᵢ) ranges from 3.03 to 8.46. Based on the results of the first cycle life test, the second cycle life test, and the third cycle life test, reducing the surface complexity (i.e., Dₘ) and increasing the radius of gyration (i.e., R_{g}) of spherulites not only helps improve the resistance stability of the over-current protection device but also enhances its durability, making it suitable for electronic apparatuses requiring higher voltage endurance.

The above-described embodiments of the present invention are intended to be illustrative only. Numerous alternative embodiments may be devised by persons skilled in the art without departing from the scope of the following claims.

What is claimed is:

1. An over-current protection device, comprising:
an electrode layer having a top metal layer and a bottom metal layer; and
in a heat-sensitive layer contacting the top metal layer and the bottom metal layer, and being laminated therebetween, wherein the heat-sensitive layer exhibits a positive temperature coefficient (PTC) characteristic and comprises:
a polymer matrix comprising a fluoropolymer, wherein the fluoropolymer has a plurality of spherulites, and a fractal dimension of each spherulite is equal to or less than 12; and
a conductive filler dispersed in the polymer matrix, thereby forming an electrically conductive path in the heat-sensitive layer.

2. The over-current protection device of claim 1, wherein the fractal dimension of each spherulite ranges from 7 to 12.

3. The over-current protection device of claim 1, wherein each spherulite has a radius at least of 35 Å.

4. The over-current protection device of claim 3, wherein the radius of each spherulite ranges from 35 Å to 43 Å.

5. The over-current protection device of claim 1, wherein the total volume of the heat-sensitive layer is calculated as 100%, and the fluoropolymer accounts for 55% to 68%.

6. The over-current protection device of claim 5, wherein the fluoropolymer is selected from the group consisting of polyvinylidene difluoride, polytetrafluoroethylene, ethylene-tetrafluoroethylene copolymer, tetrafluoroethylene-hexafluoro-propylene copolymer, perfluoroalkoxy modified tetrafluoroethylenes, poly (chlorotri-fluorotetrafluoroethylene), vinylidene fluoride-tetrafluoroethylene copolymer, tetrafluoroethylene-perfluorodioxole copolymer, vinylidene fluoride-hexafluoropropylene copolymer, and vinylidene fluoride-hexafluoropropylene-tetrafluoroethylene terpolymer, and a mixture or copolymer of combinations thereof.

7. The over-current protection device of claim 6, wherein the fluoropolymer consists of polyvinylidene difluoride and polytetrafluoroethylene.

8. The over-current protection device of claim 7, wherein the total volume of the heat-sensitive layer is calculated as 100%, and polyvinylidene difluoride accounts for 56% to 62% and polytetrafluoroethylene accounts for 3% to 5%.

9. The over-current protection device of claim 1, wherein the conductive filler consists of carbon black.

10. The over-current protection device of claim 1, wherein the heat-sensitive layer has a thickness ranging from 0.1 mm to 0.2 mm.

11. The over-current protection device of claim 1, wherein the over-current protection device has a top-view area ranging from 4 mm² to 16 mm².

12. The over-current protection device of claim 1, wherein the over-current protection device has a first resistance-jump ratio ranging from 1 to 3, wherein:
the over-current protection device has an initial electrical resistance;
the over-current protection device has a first electrical resistance when cooled back to room temperature after a cycle life test with an applied power of 24V/50 A for 6000 cycles; and
the first resistance-jump ratio is obtained by dividing the first electrical resistance by the initial electrical resistance.

13. The over-current protection device of claim 1, wherein the over-current protection device has a second resistance-jump ratio ranging from 2 to 5, wherein:
the over-current protection device has an initial electrical resistance;
the over-current protection device has a second electrical resistance when cooled back to room temperature after a cycle life test with an applied power of 30V/40 A for 6000 cycles; and
the second resistance-jump ratio is obtained by dividing the second electrical resistance by the initial electrical resistance.

14. The over-current protection device of claim 1, wherein an endurable voltage of the over-current protection device is 36V, whereby the over-current protection device is able to withstand an applied power of 36V/33 A for 6000 cycles without burnout.

15. The over-current protection device of claim 1, wherein the over-current protection device has a third resistance-jump ratio ranging from 3 to 9, wherein:
the over-current protection device has an initial electrical resistance;
the over-current protection device has a third electrical resistance when cooled back to room temperature after a cycle life test with an applied power of 36V/33 A for 6000 cycles; and
the third resistance-jump ratio is obtained by dividing the third electrical resistance by the initial electrical resistance.
